(19) United States
(12) Patent Application Publication
(10) Pub. No.: US 2011/0127211 A1
(43) Pub. Date: Jun. 2, 2011

(54) DIESEL FUEL FILTER

(75) Inventors: Kyungjin HAN, Hwaseong-si (KR); Chunkyu JANG, Suwon-si (KR)

(73) Assignees: Hyundai Motor Company, Seoul (KR); Kia Motors Corporation, Seoul (KR)

(21) Appl. No.: 12/873,824

(22) Filed: Sep. 1, 2010

(30) Foreign Application Priority Data
Dec. 2, 2009 (KR) 10-2009-0118692

(51) Int. Cl. B01D 35/30

(52) U.S. Cl. 210/446; 210/483; 210/487; 210/490

(57) ABSTRACT

A diesel fuel filter assembly may include a first filter paper combining moisture particles of water contained in diesel fuel to increase the size of the water and a second filter paper that filters off lumps of moisture particles of the water enlarged by the first filter paper.

### CROSS-REFERENCE TO RELATED APPLICATIONS

The present application claims priority to Korean Patent Application No. 10-2009-0118692 filed Dec. 2, 2009, the entire contents of which is incorporated herein for all purposes by this reference.

### BACKGROUND OF THE PRESENT INVENTION

1. Field of the present invention

The present invention relates to a diesel fuel filter, particularly a diesel fuel filter that can effectively remove water contained in diesel fuel, using two filter elements.

2. Description of Related Art

A diesel fuel system of vehicles in the related art is shown in FIG. 1, in which a fuel pump 2 pumps out diesel fuel in a fuel tank 1, the pumped fuel is delivered to a high-pressure fuel pump 4, with foreign substances removed through a diesel fuel filter 3, high-pressure fuel pump 4 makes the fuel into a extra-high-pressure state close to a gas state and then supplies it to a common rail 5, and the fuel supplied to the common rail 5, as described above, is supplied to an engine through a high-pressure injector 6.

It is required to filter water and foreign substances from at diesel fuel filter 3 to prevent damage to the common rail in the process of supplying the diesel fuel, as described above.

FIG. 2 is a cross-sectional view showing the configuration of a diesel fuel filter according to the related art, in which a diesel fuel filter 3 includes a head assembly 3a that controls the flow of fuel to the inlet and the outlet, a heater 3b that heats paraffin that is solidified by a drop in temperature in winter to melt, a cartridge 3c that removes water and foreign substances from the diesel fuel, and a water sensor 3d that detects and informs the amount of water removed by the cartridge.

The diesel fuel configured as described above in the related art has a structure in which, as indicated by arrows in FIG. 2, diesel fuel flows inside through the head assembly is filtered such that water and foreign substances are removed by the cartridge, purified through the center channel of the cartridge, and then discharged outside through the head assembly.

FIG. 3 is a cross-sectional view illustrating in detail a process of filtering water and foreign substances in a diesel fuel filter according to the related art, in which diesel fuel 7 containing water 7a and foreign substances is filtered through a filter paper 3e of a cartridge, and the purified diesel fuel 7b is discharged upward through the center channel and supplied to an engine, while the water filtered by the filter paper drops to the bottom of the filter along the surface of the filter paper by the weight, thereby forming collecting water 7c.

However, the structure of the diesel fuel filter of the related art described above has a defect that although water and foreign substances are filtered by the filter paper, fine moisture particles are not filtered through the filter paper, such that the filtering performance of the diesel fuel filter is deteriorated.

The information disclosed in this Background of the present invention section is only for enhancement of understanding of the general background of the present invention and should not be taken as an acknowledgement or any form of suggestion that this information forms the prior art already known to a person skilled in the art.

### BRIEF SUMMARY OF THE PRESENT INVENTION

Various aspects of the present invention are directed to provide a diesel fuel filter that effectively prevents damage to a diesel fuel system by securely filtering off water and foreign substances contained in diesel fuel to improve filtering performance.

In an aspect of the present invention, the diesel fuel filter assembly may include a first filter paper combining moisture particles of water contained in diesel fuel to increase the size of the water, and a second filter paper that filters off lumps of moisture particles of the water enlarged by the first filter paper.

The diesel fuel filter assembly may further include a filter housing receiving the first and second filter papers therein, wherein the first filter paper encloses the second filter paper and an input passage is formed between the first filter paper and the filter housing such that the diesel fuel is supplied therethrough.

A collection passage may be formed between the first filter paper and the second filter paper to collect the lumps of moisture particles of the water that is passed through the first filter paper and an output passage is formed in the second filter paper to discharge a purified diesel fuel therethrough.

A collection chamber fluid-communicating with the collection passage may be formed at a lower portion of the filter housing to collect therein the lumps of moisture particles of the water that is passed through the first filter paper or lumps of moisture particles of the water combined in the collection passage.

An upper partition may be attached to upper portions of the first filter paper, the collection passage and the second filter paper, and a lower partition may be attached to lower portions of the input passage, the first filter paper, the second filter paper and the output passage.

The first filter paper may be formed of PBT(meltblown) and cellulose layer

The second filter paper may be formed of a glass fiber layer.

The second filter paper may be coaxially inserted in the first filter paper, wherein the first filter paper and the second filter paper are inserted in a filter housing, with upper and lower partitions attached to the upper ends and the lower ends of the first filter paper and the second filter paper respectively.

According to a diesel fuel filter of the present invention, as diesel fuel containing water and foreign substances is filtered by a first filtering member, moisture particles combine with each other and the size increases. Thereafter, the moisture particles with the increased size are filtered off by a second filtering member such that the fine moisture particles in the diesel fuel are more effectively and securely removed. Therefore, it is possible to improve filtering performance and prevent the diesel fuels supply system from being damaged or broken by diesel fuel of low quality.

The methods and apparatuses of the present invention have other features and advantages which will be apparent from or are set forth in more detail in the accompanying drawings, which are incorporated herein, and the following Detailed Description of the present invention, which together serve to explain certain principles of the present invention.

### BRIEF DESCRIPTION OF THE DRAWINGS

FIG. 1 is a view showing the configuration of a diesel fuel supply system according to the related art.

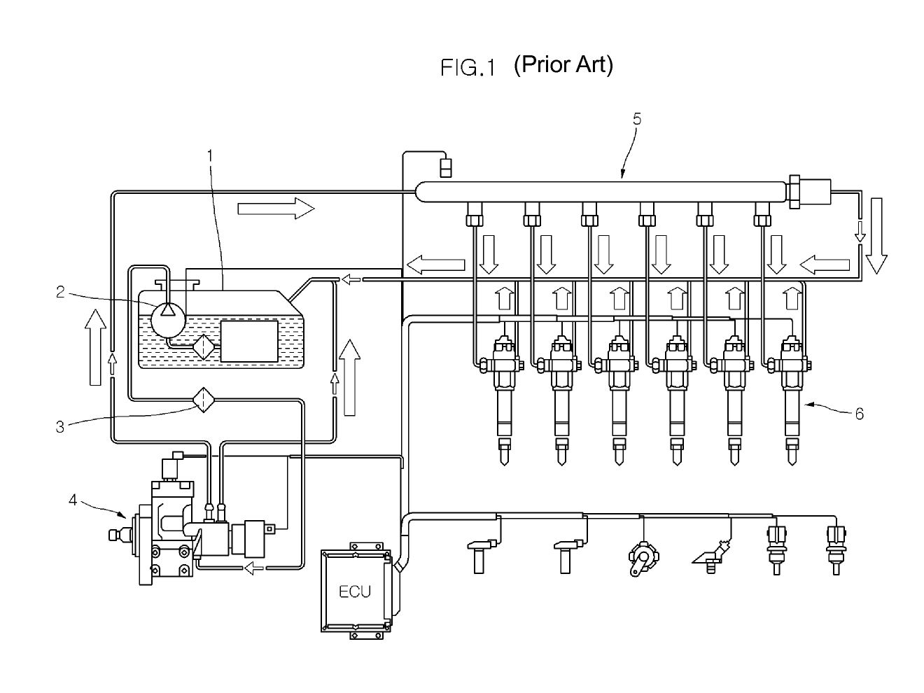

FIG. 2 is a cross-sectional view of a diesel fuel filter according to the related art.

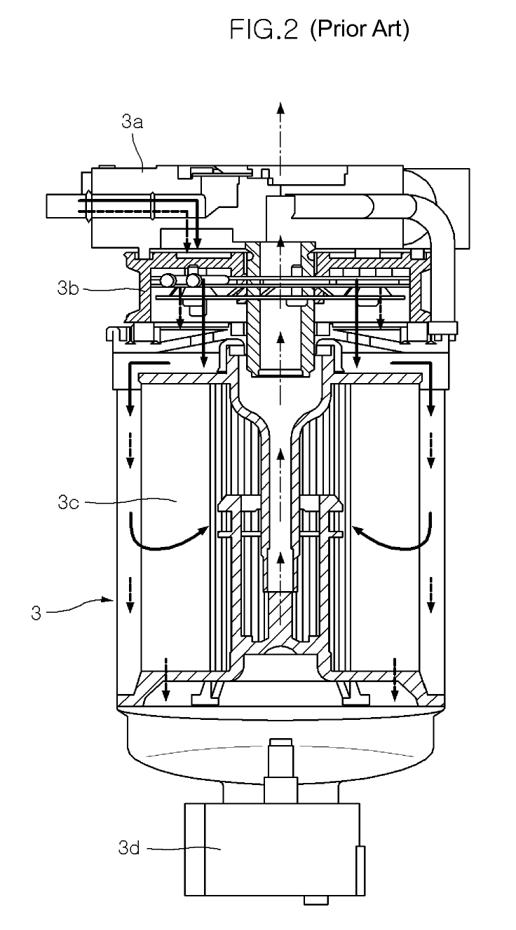

FIG. 3 is a cross-sectional view illustrating a filtering process of the diesel fuel filter according to the related art.

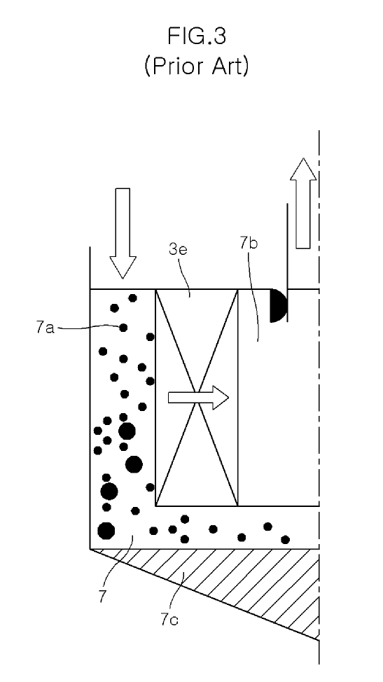

FIG. 4 is a perspective view of an exemplary diesel fuel filter according to the present invention.

FIG. 5 is a cross-sectional view illustrating a filtering process of the exemplary diesel fuel filter according to the present invention.

It should be understood that the appended drawings are not necessarily to scale, presenting a somewhat simplified representation of various features illustrative of the basic principles of the present invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the present invention(s) will be described in conjunction with exemplary embodiments, it will be understood that present description is not intended to limit the present invention(s) to those exemplary embodiments. On the contrary, the present invention(s) is/are intended to cover not only the exemplary embodiments, but also various alternatives, modifications, equivalents and other embodiments, which may be included within the spirit and scope of the present invention as defined by the appended claims.

Hereinafter, exemplary embodiments of the present invention will be described in detail with reference to the accompanying drawings.

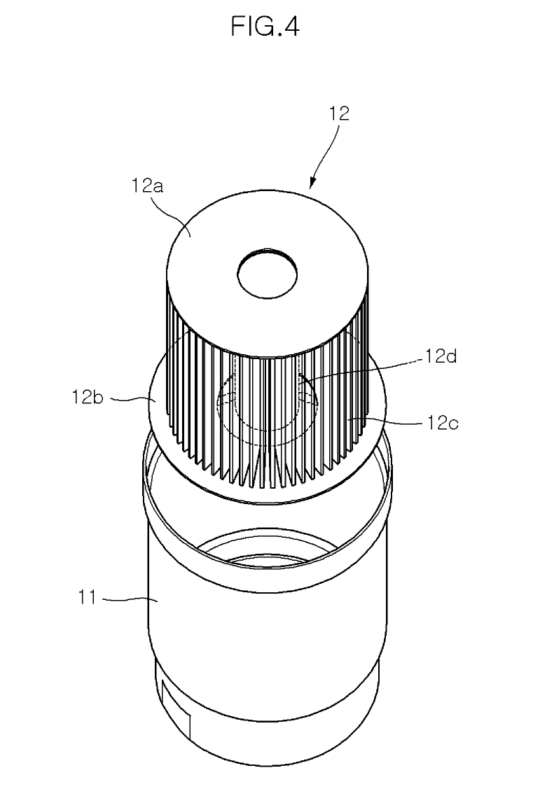

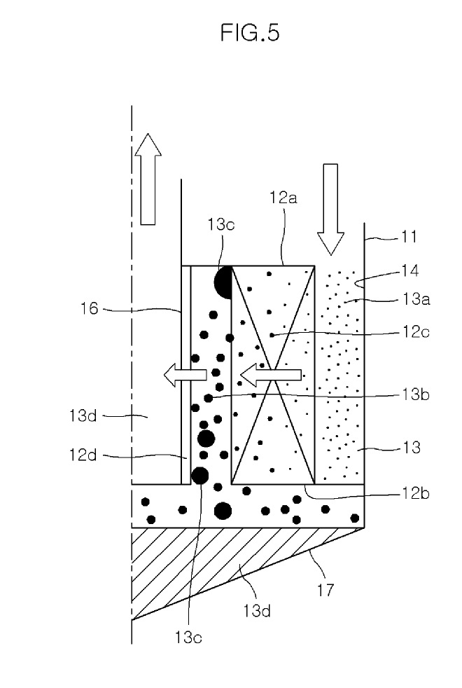

FIGS. 4 and 5 are a perspective view and a cross-sectional view respectively showing the configuration of a diesel fuel filter according to an exemplary embodiment of the present invention, which includes a cylindrical filter housing 11 with one side open and a filter 12 inserted in filter housing 11 and filtering off water and foreign substances for purification.

Filter 12 has an upper partition 12a and a lower partition 12b that are disposed up and down at a predetermined distance from each other, a first filter paper 12c that has a relatively large diameter and is disposed in a space between the upper partition 12a and the lower partition 12b, and a second filter paper 12d that has a relatively small diameter and is coaxially inserted in first filter paper 12c.

Partitions 12a and 12b cover the upper and lower ends of first and second filter papers 12c, 12d in order to supply the diesel fuel through an input passage 14 formed between the cylindrical filter housing 11 and the first filter paper 12c to guide the diesel fuel to pass through the first filter paper 12c.

First filter paper 12c is formed of a PBT(meltblown) and cellulose layer to increase the size of moisture particles by combining the fine moisture particles.

Second filter paper 12d is formed of a glass fiber layer to remove remaining water after passing through the first filter paper.

FIG. 5 is a cross-sectional view illustrating a filtering process of the diesel fuel filter having the above configuration, in which, while diesel fuel 13 containing fine moisture particles 13a and foreign substances, which has flowed in the input passage 14, passes through first filter paper 12c by fuel pressure, fine moisture particles 13a of water combine with each other into lumps of moisture particles 13b in a collection passage 15 formed between the first filter paper 12c and the second filter paper 12d.

At the bottom portion of the filter housing 11, a collection chamber 17 is formed and the collection passage 15 fluid-communicates with the collection chamber 17 such that some lump of moisture particles 13b combine each other to form the lump of weighty moisture particles 13c and then the moisture particles 13b and 13c drop and collect into the collection chamber 17 by weight.

After the lump of moisture particles 13b and 13c are filtered off by the second filter paper 12d, only the purified diesel fuel 13d is discharged upward through the output passage 16 and supplied to an engine.

Therefore, since the fine moisture particles and foreign substances contained in the diesel fuel are filtered off through the two filter papers and only the purified diesel fuel is supplied to the engine, it is possible to prevent the diesel fuel supply system from being damaged or broken by the foreign substances in the diesel fuel and improve the filtering performance, thereby improving the engine power.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof It is intended that the scope of the invention be defined by the Claims appended hereto and their equivalents.

What is claimed is:

1. A diesel fuel filter assembly comprising:
a first filter paper combining moisture particles of water contained in diesel fuel to increase the size of the water; and
a second filter paper that filters off lumps of moisture particles of the water enlarged by the first filter paper.

2. The diesel fuel filter assembly as defined in claim 1, further comprising a filter housing receiving the first and second filter papers therein, wherein the first filter paper encloses the second filter paper and an input passage is formed between the first filter paper and the filter housing such that the diesel fuel is supplied therethrough.

3. The diesel fuel filter assembly as defined in claim 2, wherein a collection passage is formed between the first filter paper and the second filter paper to collect the lumps of moisture particles of the water that is passed through the first filter paper and an output passage is formed in the second filter paper to discharge a purified diesel fuel therethrough.

4. The diesel fuel filter assembly as defined in claim 3, wherein a collection chamber fluid-communicating with the collection passage is formed at a lower portion of the filter housing to collect therein the lumps of moisture particles of the water that is passed through the first filter paper or lumps of moisture particles of the water combined in the collection passage.

5. The diesel fuel filter assembly as defined in claim 4, wherein an upper partition is attached to upper portions of the first filter paper, the collection passage and the second filter paper, and wherein a lower partition is attached to lower portions of the input passage, the first filter paper, the second filter paper and the output passage.

6. The diesel fuel filter assembly as defined in claim 1, wherein the first filter paper is formed of PBT(meltblown) and cellulose layer.

7. The diesel fuel filter assembly as defined in claim 1, wherein the second filter paper is formed of a glass fiber layer.

8. The diesel fuel filter assembly as defined in claim 1, wherein the second filter paper is coaxially inserted in the first filter paper.

9. The diesel fuel filter assembly as defined in claim 8, wherein the first filter paper and the second filter paper are inserted in a filter housing, with upper and lower partitions attached to the upper ends and the lower ends of the first filter paper and the second filter paper respectively.

10. A diesel fuel filter assembly comprising:
a first filter paper combining moisture particles of water contained in diesel fuel to increase the size of the water;
a second filter paper that filters off lumps of moisture particles of the water enlarged by the first filter paper; and
a filter housing receiving the first and second filter papers therein, wherein the first filter paper encloses the second filter paper and an input passage is formed between the first filter paper and the filter housing such that the diesel fuel is supplied therethrough,
wherein a collection passage is formed between the first filter paper and the second filter paper to collect the lumps of moisture particles of the water that is passed through the first filter paper and an output passage is formed in the second filter paper to discharge a purified diesel fuel therethrough.

11. The diesel fuel filter assembly as defined in claim 10, wherein a collection chamber fluid-communicating with the collection passage is formed at a lower portion of the filter housing to collect therein the lumps of moisture particles of the water that is passed through the first filter paper or lumps of moisture particles of the water combined in the collection passage.
